(19) United States
(12) Patent Application Publication
(10) Pub. No.: US 2026/0065711 A1
(43) Pub. Date: Mar. 5, 2026

(54) AI BASED BLIND DATE MATCHING SYSTEM BASED ON FACE IMAGE

(71) Applicant: Seong Jin JANG, Jeonju-si (KR)

(72) Inventor: Seong Jin JANG, Jeonju-si (KR)

(21) Appl. No.: 19/194,061

(22) Filed: Apr. 30, 2025

Related U.S. Application Data
(63) Continuation of application No. PCT/KR2025/003516, filed on Mar. 18, 2025.

(30) Foreign Application Priority Data
Aug. 27, 2024 (KR) 10-2024-0115205
Oct. 11, 2024 (KR) 10-2024-0139005

(51) Int. Cl. G06V 40/16; G06Q 50/00; G06V 10/82

(52) U.S. Cl. CPC G06V 40/172; G06Q 10/40; G06V 10/82; G06V 40/161; G06V 40/171

(57) ABSTRACT

An artificial intelligence-based blind date matching system, based on a face image, includes a matching server storing and analyzing a face image transmitted from a user terminal to generate matching information and providing matching information that is generated to the user terminal. The matching server includes an information collection unit receiving and collecting user information and the face image transmitted from the user terminal, a feature extraction unit extracting facial feature information through an artificial intelligence algorithm based on the face image collected by the information collection unit to generate a face template, a storage unit storing the face image and face template information together with the user information in a database, and a matching information generation unit comparing the face template information of a user using the user terminal.

### TECHNICAL FIELD

The present invention relates to an artificial intelligence (AI)-based blind date matching system based on face images. More specifically, the present invention relates to an AI-based blind date matching system that compares and analyzes faces of multiple users stored in a server through AI deep learning to find and introduce the most similar person.

### BACKGROUND ART

Examples of arranged meetings for dating include blind dates, meetings, or matchmaking for marriage. A matchmaking meeting refers to a form of meeting in which a matchmaker intervenes between a man and a woman who want to date, and has been mainly done through acquaintances, relatives, or matchmakers, but recently, the matchmaking meeting has expanded to meetings through marriage information companies, which are commercialized forms.

A marriage information company stores specific information on each registered man and woman in a computerized system, conducts matching between registered members according to their conditions, and makes a meeting and generates additional sales when a marriage is concluded. In order to find the desired partner from the vast amount of member information data, technologies have been developed to search for members of the opposite sex by searching for various conditions, such as region, age, body type, and occupation, and matching algorithms have been improved to recommend carefully selected members.

However, the matching algorithms are generally mainly used to find the partner who best matches the input conditions by having a user input the desired conditions.

Because matching information is mainly generated based on conditions through matching algorithms, it is difficult to have mutual feelings, and it is rare for users to lead to actual dating or marriage.

It is known that both men and women are instinctively attracted to people who resemble each other in dating, so there is a need for an algorithm that finds similar people and matches the people, rather than a matching algorithm based on conditions. However, there is currently no development of such a matching system.

### Technical Problem

In order to solve problems of the prior art, an objective of the present invention is to provide an artificial intelligence (AI)-based blind date matching system that compares and analyzes faces of multiple users stored in a server through AI deep learning to find and introduce the most similar opposite sex.

Another objective of the present invention is to provide an AI-based blind date matching system that may provide matching information more quickly and accurately by primarily selecting comparison data through separate classification criteria or restriction conditions in the process of comparing and analyzing faces of multiple users and thereby reducing the matching information generation time.

Another objective of the present invention is to provide an AI-based blind date matching system that may provide more accurate matching information by providing matching target users according to ranking to enable a user to select and by analyzing the user's selection results to reflect the analyzed result in selecting a matching target user.

### Technical Solutions

The present invention provides an artificial intelligence-based blind date matching system based on a face image, including a matching server storing and analyzing a face image transmitted from a user terminal to generate matching information and providing matching information that is generated to the user terminal, wherein the matching server includes an information collection unit receiving and collecting user information and the face image transmitted from the user terminal, a feature extraction unit extracting facial feature information through an artificial intelligence algorithm based on the face image collected by the information collection unit to generate a face template, a storage unit storing the face image and face template information together with the user information in a database, a matching information generation unit comparing the face template information of a user using the user terminal that transmits a matching request signal with pieces of face template information of other users stored in the storage unit and generating matching information when receiving the matching request signal transmitted from the user terminal, and an information provision unit transmitting the matching information generated by the matching information generation unit to the user terminal that transmits the matching request signal.

In this case, the matching information generation unit may compare face template information of a matching request user who is the user of the user terminal that transmits the matching request signal, with the pieces of face template information of other users, extract a user with the face template information having the highest similarity to the face template information of the matching request user according to the comparison result, and match the extracted user with the matching request user to generate the matching information.

Also, the matching information generation unit may include a similarity calculation unit that calculates similarity by comparing the face template information of the matching request user with the pieces of face template information of the other users stored in the storage unit, and a matching target selection unit that selects the user having the highest similarity according to a calculation result of the similarity calculation unit as a matching target user to generate the matching information, and the matching information may include a face image and user information of the matching target user, and a similarity value of the matching target user.

Also, the matching information generation unit may further include a primary selection unit that primarily selects users according to the restriction condition from among the user information stored in the storage unit by considering the restriction condition transmitted from the user terminal, and the similarity calculation unit may calculate similarity for the users selected by the primary selection unit.

Also, the restriction condition may include a gender condition, an age condition, and a region condition.

Also, the matching information generation unit may further include a classification unit that classifies a plurality of pieces of face template information stored in the storage unit into a plurality of groups according to facial features, and the similarity calculation unit may calculate the similarity by comparing the face template information of the matching request user with the pieces of face template information of the other users among the plurality of groups classified by the classification unit and calculate the similarity.

Also, the classification unit may classify the plurality of pieces of face template information into the plurality of groups for each classification criterion based on a plurality of classification criteria according to the facial features, and when receiving the classification criterion transmitted from the user terminal by input of the matching request user, the similarity calculation unit may calculate the similarity within a group to which the face template information of the matching request user belongs among the plurality of groups classified according to the transmitted classification criterion.

Also, the matching target selection unit may select a plurality of matching target users in order of high similarity up to a preset standard ranking so as to be selected by the matching request user, select a user selected by the matching request user as a final matching target user, and generate the matching information.

Also, the matching information generation unit may further include a selection analysis unit that analyzes a selection result of the final matching target user selected by the matching request user and extracts a facial feature with the highest similarity among facial features between the matching request user and the final matching target user, and the similarity calculation unit may calculate the similarity by applying a weight to the facial feature extracted by the selection analysis unit.

According to the present invention, faces of multiple users stored in a server may be compared and analyzed through AI deep learning to find and introduce the most similar opposite sex, thereby increasing the probability of successful matching.

Also, by primarily selecting comparison data through separate classification criteria or restriction conditions in a process of comparing and analyzing faces of multiple users, matching information generation time may be reduced, thereby providing matching information more quickly and accurately.

Also, by providing matching target users according to ranking to enable a user to select, and by analyzing results of the user's selection and reflecting the analyzed result in the process of selecting matching target users, there is an effect of providing more accurate matching information.

### BRIEF DESCRIPTION OF DRAWINGS

FIG. 1 is a diagram conceptually illustrating the entire configuration of a blind date matching system according to an embodiment of the present invention.

FIG. 2 is a functional block diagram functionally illustrating a configuration of a matching server of a blind date matching system according to an embodiment of the present invention.

FIG. 3 is a functional block diagram functionally illustrating a configuration of a matching information generation unit of a matching server according to an embodiment of the present invention.

FIG. 4 is a flowchart sequentially illustrating operation states of a blind date matching system according to an embodiment of the present invention.

### DETAILED DESCRIPTIONS

The present invention relates to an artificial intelligence-based blind date matching system based on a face image and may include a matching server storing and analyzing a face image transmitted from a user terminal to generate matching information and providing matching information that is generated to a user terminal, wherein the matching server may include an information collection unit receiving and collecting user information and a face image transmitted from the user terminal, a feature extraction unit extracting facial feature information through an artificial intelligence algorithm based on a face image collected by the information collection unit to generate a face template, a storage unit storing the face image and face template information together with the user information in a database, a matching information generation unit comparing the face template information of a user using the user terminal with face template information of another user stored in the storage unit and generating matching information when receiving a matching request signal transmitted from the user terminal, and an information provision unit transmitting the matching information generated by the matching information generation unit to the user terminal that transmits the matching request signal. Here, the term “unit” may refer to hardware (computing components), software or a combination thereof, and may include one or more processors, one or more memories, and/or computer programs stored in the one or more memories connected to the one or more processors, and when executed, configured to perform various functions described hereinafter.

Hereinafter, preferred embodiments of the present invention are described in detail with reference to the attached drawings. First, when adding reference numerals to components of respective drawings, it should be noted that the same components are given the same numerals as much as possible even when the same numerals are illustrated in different drawings. Also, in describing the present invention, when it is determined that a specific description of a related known configuration or function may obscure the gist of the present invention, detailed descriptions thereof are omitted.

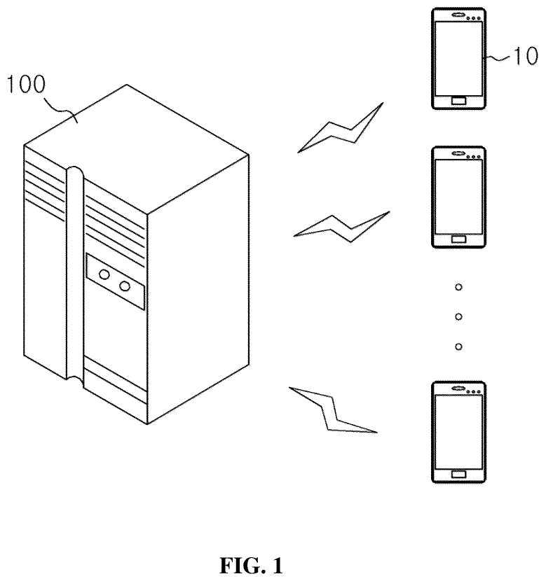

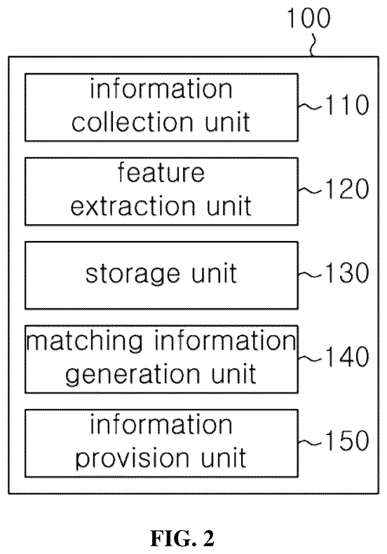

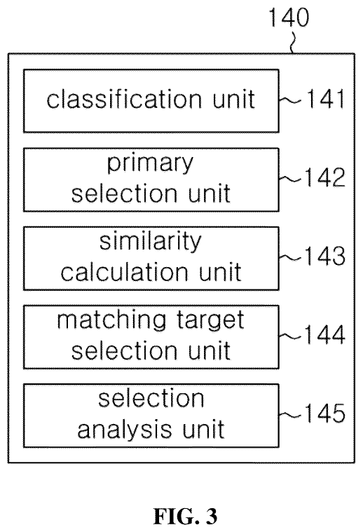

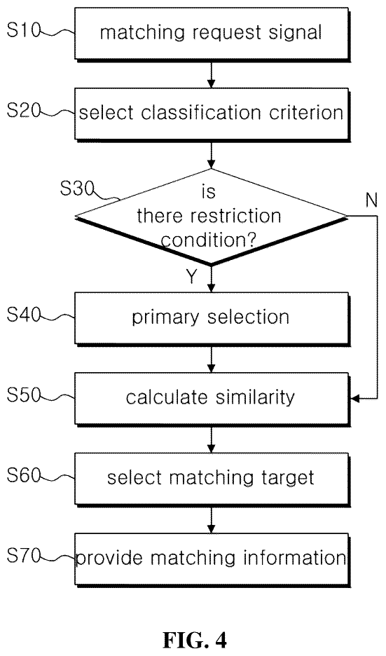

FIG. 1 is a diagram conceptually illustrating the entire configuration of a blind date matching system according to an embodiment of the present invention, FIG. 2 is a functional block diagram functionally illustrating a configuration of a matching server of the blind date matching system according to an embodiment of the present invention, FIG. 3 is a functional block diagram functionally illustrating a configuration of a matching information generation unit of the matching server according to an embodiment of the present invention, and FIG. 4 is a flowchart sequentially illustrating operation states of the blind date matching system according to an embodiment of the present invention.

The blind date matching system according to an embodiment of the present invention is configured to include a matching server 100 that is communicatively connected to a plurality of user terminals 10.

The matching server 100 receives face images from multiple user terminals 10, stores and analyzes the face images, generates matching information on the most similar user based on the analysis results, and provides the matching information to the plurality of user terminals 10.

The user terminal 10 is connected to the matching server 100 through a communication network. When a matching request signal is transmitted to the matching server 100 through the user terminal 10, the matching server 100 generates matching information on a user who most resembles a matching request user, and provides the matching information to the user terminal 10.

The user terminal 10 may be a computer device but is not limited thereto and may include a smart phone, a mobile phone, a navigation device, a laptop computer, a digital broadcasting terminal, a PDA (Personal Digital Assistants), a PMP (Portable Multimedia Player), a tablet PC, and so on. For example, the user terminal 10 may communicate with the matching server 100 through a communication network using a wireless or wired communication method.

The communication network is not limited to the communication method and may include, for example, communication methods utilizing a mobile communication network, wired Internet, wireless Internet, and a broadcasting network, as well as short-range wireless communication between devices. For example, the communication network may include one or more networks among networks, such as a PAN (personal area network), a LAN (local area network), a may (campus area network), a MAN (metropolitan area network), a WAN (wide area network), a BBN (broadband network), and the Internet. Also, the communication network may include any one or more of network topologies including a bus network, a star network, a ring network, a mesh network, a star-bus network, a tree, a hierarchical network, and so on but is not limited thereto.

The user terminal 10 according to an embodiment of the present invention may transmit a matching request signal through a web-based program provided by the matching server 100 or output the received matching information on a screen. For example, the matching server 100 may variably utilize resources for a large number of user services based on MSA (Micro Service Architecture). Therethrough, the same user environment may be provided on various platforms, such as PCs, tablets, and mobile phones without a separate dedicated application. However, the present invention is not limited thereto, and the user terminal 10 may transmit a matching request signal through a separate dedicated application provided by the matching server 100 or output the received matching information on a screen. Here, the dedicated application may be provided through an application market of a known smartphone operating system, such as the Android Store or App Store, or may also be provided directly from the matching server 100.

The matching server 100 analyzes face images by using an artificial intelligence algorithm to generate matching information and transmits an analysis result to the user terminal 10. The matching server 10 has the same hardware configuration as a typical web server, and may include a program module that performs various functions by being implemented with various languages, such as C, C++, Java, Visual Basic, and Visual C in terms of software. Also, the matching server 100 may be implemented with a web server program that is provided in various ways according to an operating system, such as DOS, Window, Linux, Unix, Macintosh, Android, or iOS on general server hardware.

The matching server 100 according to an embodiment of the present invention includes an information collection unit 110, a feature extraction unit 120, a storage unit 130, a matching information generation unit 140, and an information provision unit 150.

The information collection unit 110 receives and collects user information and face images from multiple user terminals 10. The user information and face images collected from the user terminals 10 are stored in a database together with face template information described below and stored in the storage unit 130.

The feature extraction unit 120 extracts face feature information through an artificial intelligence algorithm based on the face images collected by the information collection unit 110 and generates a face template.

In order to describe more detail a process of generating the face template through an artificial intelligence algorithm, a process of detecting and cutting out a face image from the entire image is first performed through a deep learning-based face detection algorithm. In this process, face images are detected through a learning result from a large number of images. Thereafter, the face images are aligned through landmarks of the face images. After performing a face image detection and alignment operation, a process of extracting face features is performed. The face feature extraction process is a process of generating a face template by receiving a preprocessed image as an input value. The face template is numeric data that represents features extracted from a face image by using a deep learning model. More specifically, the face template is a high-dimensional vector obtained by digitizing a main feature extracted from the face images and is a collection of data representing face elements, such as eyes, nose, mouth, and face outline. Because faces of respective persons have different features, face templates thereof may be expressed as different numbers, and the face template of each person may be considered as unique biometric information on each person. Therefore, the face template information may be used for similarity calculation and so on for comparing with other face images.

When a matching request signal is transmitted from the user terminal 10, the matching information generation unit 140 generates matching information by comparing the face template information of a user of the user terminal 10 that transmits the matching request signal with the face template information of another user stored in the storage unit 130.

The matching information generated by the matching information generation unit 140 is transmitted to the user terminal 10 that transmits the matching request signal by the information provision unit 150.

In this case, in a process of generating the matching information through the matching information generation unit 140, the face template information of the matching request user is compared with the face template information of another user, a user with the highest similarity is matched with the matching request user, and thereby, matching information is generated.

That is, the matching information generation unit 140 compares the face template information of the matching request user who transmits the matching request signal with pieces of the face template information of other users, extracts a user with the face template information having the highest similarity to that of the matching request user according to the comparison result, and matches the extracted user with the matching request user to generate matching information.

This matching information generation unit 140 includes a similarity generation unit 143 that compares the face template information of the matching request user stored in the storage unit 130 with the face template information of another user to calculate the similarity, and a matching target selection unit 144 that selects a user with the highest similarity as the matching target user based on the calculation result of the similarity generation unit 143 and generates matching information.

In this case, the matching information may include a face image and user information of the matching target user along with a similarity value of the matching target user. n

In this way, by extracting a user who most resembles a matching request user by using the matching information generation unit 140 through an artificial intelligence algorithm and providing the user as the matching information, the most similar person who is known to be instinctively most attractive may be matched, and the matching success probability may be improved therethrough.

In this way, when all the face images of all users stored in the storage unit 130 are analyzed in the process of selecting the matching target, a gender, an age, a region, and so on may not be filtered at all, and an operation time of the matching server 100 may take a long time, and accordingly, the matching information generation unit 140 may include a separate primary selection unit 142.

The primary selection unit 142 may be configured to primarily select a user according to a restriction condition among multiple pieces of user information stored in the storage unit 130 by considering the restriction condition transmitted from the user terminal 10. In this case, the restriction condition may include a gender condition, an age condition, and a region condition. Thereafter, the similarity calculation unit 143 may calculate the similarity only for a user selected by the primary selection unit 142.

In this case, a restriction condition selection input screen on which the restriction condition may be selectively input may be output to the user terminal 10.

In this way, by limiting a range of a comparison target user to a certain range according to the restriction condition set by a user in a process of selecting a matching target, an operation time of the matching server 100 may be reduced, and accordingly, matching information may be generated more quickly, and a matching partner desired by the user may be selected more accurately.

Also, the matching information generation unit 140 may further include a classification unit 141 to reduce a calculation process of an artificial intelligence algorithm in the process of selecting a matching target.

The classification unit 141 classifies a plurality of pieces of face template information stored in the storage unit 130 into a plurality of groups according to facial features. The similarity calculation unit 143 compares the face template information of a matching request user with the face template information of another user within a group to which the face template information of the matching request user belongs among a plurality of groups classified by the classification unit 141 and calculates the similarity.

That is, the classification unit 141 may classify the plurality of pieces of face template information stored in the storage unit 130 into a plurality of groups depending on facial features, and the similarity calculation unit 143 may compare pieces of face template information with each other only in the same group to which a matching request user belongs among the plurality of groups classified in this way, and accordingly, a similarity calculation process may be completed more quickly without the need to compare all of data.

This classification process may be implemented through a K-means clustering technique. K-means clustering is an unsupervised learning algorithm that divides data into multiple groups (clusters). This algorithm divides the data based on a distance to the centroid of each cluster and calculates a distance between facial feature vectors to collect users with similar faces into the same cluster. A clustering process is performed by first randomly setting K cluster centers. A distance between each user's face template (facial feature vector) and each cluster center is calculated, and the user's face template is assigned to the closest cluster centroid. An average of all face vectors assigned to each cluster is calculated, and the cluster centroid is updated. In this case, the centroid of each cluster moves depending on a data distribution. The updating process is repeated until there is no more change in the cluster centroid, or until the number of set repetitions is reached, face templates of users are rearranged, and the centroids are updated. When this process is completed, users with similar faces belong to the same cluster.

In this way, users with similar facial features are grouped into clusters in advance, and when a matching request signal is transmitted, a comparison is performed only within the corresponding cluster. Accordingly, time is reduced because the matching operation is performed only for some groups, not the entire dataset.

Meanwhile, unlike the K-means clustering technique, the classification unit 141 may also classify the facial template information into multiple groups according to a separate classification criterion.

The classification criterion may be transmitted from the user terminal 10 through the selection of a matching request user. For example, a screen for selecting important facial features among facial features may be output to the user terminal 10, and a user may select one of the facial features displayed on the screen. The feature information of a face which is a selection target may include, for example, a face shape, an eye shape, a nose shape, a mouth shape, and so on. When the classification criterion based on the facial features are transmitted from the user terminal 10, the classification unit 141 classifies the entire facial template information into multiple groups based on the transmitted classification criterion.

For example, when the matching request user selects a face shape as the classification criterion, the classification unit 141 may classify the entire facial template information into a square, an egg-shape, a round shape, and so on based on the face shape. The similarity calculation unit 143 may calculate the highest similarity by comparing the face template information within the group (for example, an egg-shape) to which a face type of the matching requesting user belongs among the classified face types.

In this case, the classification unit 141 may classify the face template information into multiple groups based on multiple classification criteria in advance and separately store groups for each classification criterion in the storage unit 130. When groups corresponding to each classification criterion are separately stored by the classification unit 141 in this way, after the matching request user selects the classification criterion, a specific group may be directly selected from the previously classified groups instead of performing the corresponding classification operation, and similarity may be calculated within the selected group. Therefore, the similarity may be quickly calculated.

Accordingly, as illustrated in FIG. 4, a matching request signal is first transmitted from the user terminal 10 (S10), and a classification criterion is selected and transmitted together with the matching request signal (S20). In the process of selecting the classification criterion, a restriction condition may also be selected and transmitted together. Thereafter, the matching server 100 determines whether the restriction condition is transmitted from the user terminal 10 together with the matching request signal (S30), and primarily selects a user according to the restriction condition through the primary selection unit 142 (S40). Thereafter, the similarity calculation unit 143 compare the users with face template information of the users which are primarily selected and calculate similarity therebetween (S50). In the process of calculating the similarity, the similarity may be calculated for only one of the groups classified according to the classification criterion described above. Thereafter, a user with the highest similarity is selected as a matching target user (S60), and this is generated as matching information and provided to the user terminal 10 (S70).

In this way, a user most similar to the matching request user may be selected and provided as matching information to the user.

Meanwhile, the matching target selection unit 144 may select a user with the highest similarity as the matching target user as described above, but, unlike this, multiple matching target users may be selected in order of high similarity up to a preset standard ranking (for example, a fifth level) such that the matching request user may be selected, and the user selected by the matching request user may be selected as a final matching target user to generate matching information.

In this case, the matching information generation unit may further include a selection analysis unit 145 that analyzes a result in which the matching request user selects a final matching target user and extracts a facial feature with the highest similarity among the facial features between the matching request user and the final matching target user.

The result analyzed by the selection analysis unit 145 may be reflected as feedback information in the similarity calculation process in the future. Specifically, the similarity calculation unit 143 may calculate the similarity by applying weights to the facial features extracted by the selection analysis unit 145.

For example, when the matching request user selects one of the multiple users with high similarity as the final matching target user, the selection analysis unit 145 may compare the facial templates of the matching request user with the final matching target user and analyze which facial feature is the most similar. For example, eye similarity may be analyzed to be the highest at 90. In this case, because the matching request user perceives a case where the eyes are similar to each other as the most favorable, the eye feature may be weighted when calculating the similarity in the future. That is, when the eyes are similar to each other, the eyes may have a higher similarity value than other parts.

When the final matching target selection results of users are analyzed for a large number of users, the similarity calculation method may be updated by applying weights to specific facial features in the similarity calculation process for all users as well as for a specific user.

Through the process of calculating similarity using weights, more accurate matching information may be generated.

The above description is merely an example of the technical idea of the present invention, and those having ordinary knowledge in the technical field to which the present invention pertains may make various modifications and variations without departing from the essential characteristics of the present invention. Therefore, the embodiments disclosed in the present invention are not intended to limit the technical idea of the present invention but to describe the technical idea, and the scope of the technical idea of the present invention is not limited by the embodiments. The protection scope of the present invention should be interpreted by the claims below, and all technical ideas within the equivalent scope should be interpreted as being included in the scope of the rights of the present invention.

1. An artificial intelligence-based blind date matching system based on a face image, the artificial intelligence-based blind date matching system comprising:
a matching server storing and analyzing the face image transmitted from a user terminal to generate matching information and providing the generated matching information to the user terminal,
wherein the matching server comprises one or more processors configured for:
receiving and collecting user information and the face image transmitted from the user terminal;
extracting facial feature information through an artificial intelligence algorithm based on the collected face image to generate a face template;
storing the face image and face template information together with the user information in a database;
comparing the face template information of the user using the user terminal that transmits a matching request signal with pieces of face template information of other users stored in a storage and generating the matching information when receiving the matching request signal transmitted from the user terminal; and
transmitting the generated matching information to the user terminal that transmits the matching request signal.

2. The artificial intelligence-based blind date matching system of claim 1, wherein the one or more processors are configured to compare the face template information of the user, who is defined as a matching request user, of the user terminal that transmits the matching request signal, with the pieces of face template information of other users, extracts a user among the other users with face template information having a highest similarity to the face template information of the matching request user according to a comparison result, and matches the extracted user with the matching request user to generate the matching information.

3. The artificial intelligence-based blind date matching system of claim 2, wherein the one or more processors includes: a similarity calculation processor that calculates a similarity by comparing the face template information of the matching request user with the pieces of face template information of the other users stored in the storage; and a matching target selection processor that selects the user having the highest similarity according to a calculation result of the similarity calculation processor as a matching target user to generate the matching information, and
the matching information includes a face image and user information of the matching target user, and a similarity value of the matching target user.

4. The artificial intelligence-based blind date matching system of claim 3, wherein the one or more processors include a primary selection processor that primarily selects users according to a restriction condition from among the user information stored in the storage considering the restriction condition transmitted from the user terminal, and
the similarity calculation processors calculates similarities for the users selected by the primary selection processor.

5. The artificial intelligence-based blind date matching system of claim 4, wherein the restriction condition includes a gender condition, an age condition, and a region condition.

6. The artificial intelligence-based blind date matching system of claim 3, wherein the one or more processors further includes a classification processor that classifies a plurality of pieces of face template information stored in the storage into a plurality of groups according to facial features, and
the similarity calculation processor calculates the similarity by comparing the face template information of the matching request user with the pieces of face template information of the other users among the plurality of groups classified by the classification processor.

7. The artificial intelligence-based blind date matching system of claim 6, wherein the classification processor classifies the plurality of pieces of face template information into the plurality of groups for each classification criterion based on a plurality of classification criteria according to the facial features, and
when receiving the classification criterion transmitted from the user terminal by input of the matching request user, the similarity calculation processor calculates the similarity within a group to which the face template information of the matching request user belongs among the plurality of groups classified according to the transmitted classification criterion.

8. The artificial intelligence-based blind date matching system of claim 3, wherein the matching target selection processor selects a plurality of matching target users in order of higher similarities up to a preset standard ranking so as to be selected by the matching request user, selects a user selected by the matching request user as a final matching target user, and generates the matching information.

9. The artificial intelligence-based blind date matching system of claim 8, wherein the one or more processors include a selection analysis processor that analyzes a selection result of the final matching target user selected by the matching request user and extracts a facial feature with the highest similarity among facial features between the matching request user and the final matching target user, and
the similarity calculation processor calculates the similarity by applying a weight to the facial feature extracted by the selection analysis processor.
